(19) United States
(12) Patent Application Publication
(10) Pub. No.: US 2005/0120518 A1
(43) Pub. Date: Jun. 9, 2005

(54) Caster assembly

(76) Inventors: Steven C. Thompson, Elkhart, IN (US); Timm L. Reber, White Pigeon, MI (US)

Correspondence Address: MICHAEL BEST & FRIEDRICH LLC, 401 NORTH MICHIGAN AVENUE, SUITE 1900, CHICAGO, IL, 60611-4212, US

(21) Appl. No.: 10/999,409

(22) Filed: Nov. 30, 2004

Related U.S. Application Data
(60) Provisional application No. 60/527,085, filed on Dec. 3, 2003.

(51) Int. Cl. E05D 11/10

(52) U.S. Cl. 16/320

(57) ABSTRACT

Caster assemblies and a method of operating a caster assembly is provided. In some aspects, the caster assembly includes a housing, a plate movably positioned within the housing between a retracted position and an extended position, the plate in the extended position being parallel to the plate in the retracted position, a caster wheel rotatably coupled to the plate, and a cam arm pivotally coupled to the housing, the cam arm is pivotable to cam against the plate to move the plate from its retracted position to its extended position. In some aspects, the caster assembly includes a housing, a plate movable within the housing and having two ends, a caster wheel rotatably coupled to the plate, and a cam arm pivotally coupled to the housing to pivot relative to the housing, the cam arm cams against the plate to move the two ends of the plate vertically downward relative to the housing.

### CROSS REFERENCE TO RELATED APPLICATION

This application claims the benefit of and priority of U.S. Provisional Patent Application No. 60/527,085, filed Dec. 3, 2003.

### BACKGROUND OF THE INVENTION

The present invention relates to caster assemblies and particularly to caster assemblies having a caster wheel that is movable between a retracted position within a housing of the assembly and an extended position outside the housing.

Conventional caster assemblies are typically mounted on the bottom of a structure that is desired to be movable. For example, caster assemblies can be positioned on furniture, containers, or any other structure that is to be movable. Display structures in stores are often equipped with caster assemblies. For example, a kitchen or bathroom display that includes a base on which a mock-up of a kitchen or bathroom including cabinets, sink, etc. typically includes caster wheels. The bathroom or kitchen display may be moved easily into a desired position on the store floor by rolling the display on the caster wheels.

### SUMMARY OF THE INVENTION

Conventional retractable caster assemblies, including those on store displays, can be inadequate to support the heavy loads often placed on such casters. Additionally, because of the heavy loads placed on such casters, it may be difficult for a user to operate the mechanism that moves the caster wheel from its retracted position to its extended position. A caster assembly that supports the weight of a structure to which it is coupled and is readily movable from its retracted position to its extended position by a typical user would be welcomed by users of such caster assemblies.

In some aspects, the invention provides a caster assembly including a housing, a plate movably positioned within the housing between a retracted position and an extended position, the plate in the extended position being parallel to the plate in the retracted position, a caster wheel rotatably coupled to the plate, and a cam arm pivotally coupled to the housing, wherein the cam arm is pivotable to cam against the plate to move the plate from its retracted position to its extended position.

In some aspects, the invention provides a caster assembly including a housing, a plate movable within the housing, the plate having two ends, a caster wheel rotatably coupled to the plate, and a cam arm pivotally coupled to the housing to pivot relative to the housing, wherein the cam arm cams against the plate to move the two ends of the plate vertically downward relative to the housing.

In some aspects, the invention provides a method of operating a caster assembly mountable to a structure, the method including mounting the caster assembly to a surface of the structure, the caster assembly including a housing, a plate moveable within the housing, a caster wheel rotatably coupled to the plate, and a cam arm coupled to the housing and engaging the plate, rotating the cam arm to cam the arm against the plate and thereby move the plate relative to the housing from a retracted position to an extended position, wherein the plate in the extended position is parallel to the plate in the retracted position.

Additional features and advantages of the invention will become apparent to those skilled in the art upon consideration of the following detailed description, claims and drawings.

### BRIEF DESCRIPTION OF THE DRAWINGS

The detailed description of the drawings refers to the accompanying figures in which:

FIG. 1 is a perspective view of a caster assembly with a housing shown in a first configuration;

FIG. 2 is an end view of the caster assembly with end plates removed, a caster wheel and a plate to which the caster wheel is shown mounted in a retracted position within a housing of the assembly shown in a second configuration;

FIG. 3 is an end view of the caster assembly similar to FIG. 2 showing the caster wheel and plate in an extended position;

FIG. 4 is a bottom view of the caster assembly of FIG. 2 with castor wheels removed, showing two cam arms pivotally mounted within the housing of the caster assembly to move the caster wheels from the retracted position to the extended position;

FIG. 5 is a side view of an end plate, which provides an opening in which a cam arm pivots; and

FIG. 6 is a plan view of the end plate of FIG. 5 showing the opening.

### DETAILED DESCRIPTION OF THE DRAWINGS

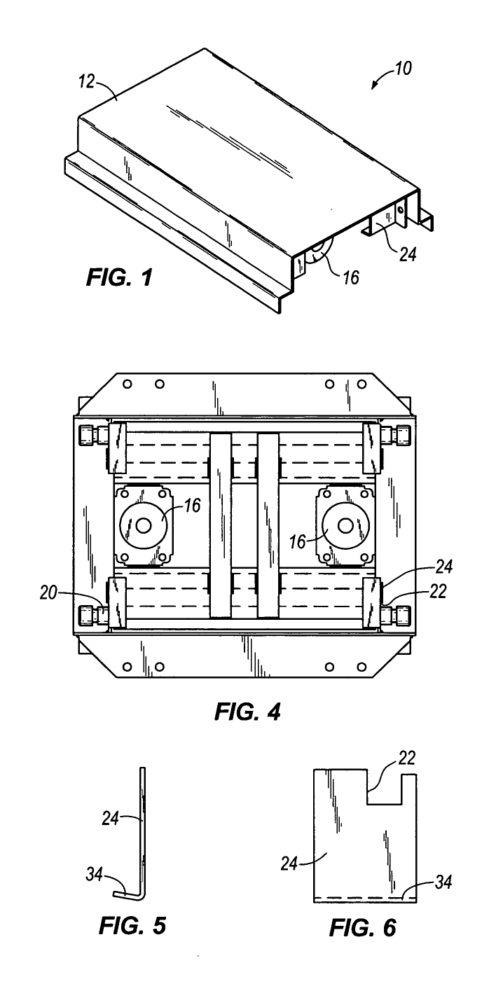

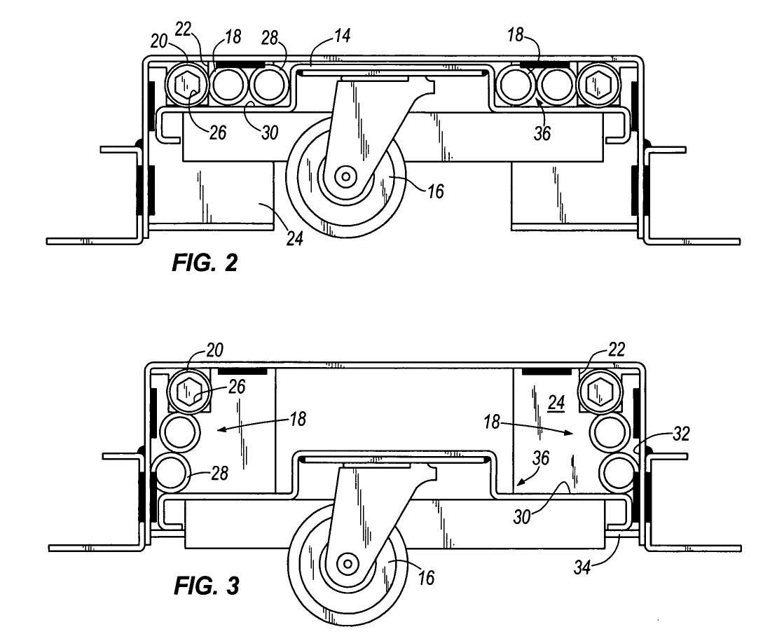

Referring to FIGS. 1-3, a caster assembly 10 includes a housing 12 and a plate 14 movable within the housing 12 and including a caster wheel 16 mounted to it. The plate 14 and the caster wheel 16 are movable between a retracted position, as shown in FIG. 2, wherein the plate 14 and wheel 16 are positioned substantially within the housing 12 out of contact with the ground when the bottom of the housing 12 rests on the floor or other support surface and an extended position, as shown in FIG. 3, wherein the wheel 16 is positioned at least partially outside the housing 12 and supports the caster assembly 10 on the floor or other support surface. The caster assembly 10, as shown in perspective in FIG. 1, includes two caster wheels 16 (only one of which can be partially seen in FIG. 1) attached to the plate 14 (see FIG. 4). However, the caster assembly 10 can include only one caster wheel 16 or more than two caster wheels 16 and still be within the scope of the present invention. Additionally, the caster assembly 10 includes both caster wheels 16 mounted to a single plate 14. However, each caster wheel 16 could be mounted to its own plate 14 and still be within the scope of the present invention.

The caster assembly 10 is mountable to a variety of structures that are to be rolled over a floor or support surface and is mountable on any surface of a structure. The housing 12 can have a variety of configurations to accommodate different structures and applications. For example, one configuration of the housing 12 is shown in FIG. 1 and a second configuration of the housing 12 is shown in FIGS. 2-4. By way of example only, a store display, such as a kitchen or bathroom mock-up, can be supported on the housing 12. In this way, the caster wheels 16 can be moved to their extended position, lifting the store display off the ground to move the display as desired. Then, when the store display is in its desired position, the caster wheels 16 can be retracted, returning the display to the ground and concealing the presence of the caster wheels 16 within the housing 12.

Referring to FIG. 2, the caster assembly 10 includes two cam arms 18 pivotally mounted within the housing 12. The cam arms 18 are constructed of three pieces of tubing welded together side-by-side. A first tube portion 20 of each cam arm 18 is longer than the remaining two pieces of tubing of each cam arm 18 and extends through openings 22 in end plates 24 of the caster assembly 10 (see FIGS. 2, 3 and 6). The end plates 24 are coupled to the housing 12, as can best be seen in FIGS. 1 and 4. The first tube portions 20 of the cam arms 18 include hex features 26 allowing a user to engage and pivot the cam arms 18 with a hex wrench. By turning the first tube portions of the cam arms 18, end portions 28 of the cam arms 18 move and cam against a cam surface 30 of the plate 14. In this way, the cam arms 18 push against the cam surface 30 of the plate 14 forcing it down within the housing 12.

As shown in FIGS. 2 and 3, the two cam arms 18, one mounted on each side within the housing 12, can be pivoted simultaneously moving each side of the plate 14 simultaneously within the housing 12. Alternatively, the cam arms 18 can be pivoted one at a time, to lower one side of the plate 14 separately from the other. In their “starting position” (FIG. 2), the cam arms 18 nest in recesses 36 of the plate 14 formed as a result of the “hat-shaped” configuration of the plate 14. As viewed in FIGS. 2 and 3, from the side, the general hat shape of plate 14 is formed by the bends of the plate 14 that create the “brim” of the hat and the recesses 36 in which the cam arms 18 nest when the assembly 10 is in its retracted position (FIG. 2). This produces a relatively low profile assembly.

The cam arms 18 are pivoted to cam the end portions 28 against the cam surface 30 of the plate 14 and move the plate 14 and the caster 16 coupled to it from their retracted position, as shown in FIG. 2, to their extended position, as shown in FIG. 3. As can be seen with reference to FIGS. 2 and 3, each cam arm 18 is rotated through an arc of slightly greater than 90 degrees before the end portions 28 of the cam arms 18 abut sidewalls 32 of the housing 12 and can be rotated no further. With the cam arms 18 rotated slightly more than 90 degrees (FIG. 3) from their starting position (FIG. 2), they are held securely in an “over-center” position and cannot freely rotate back toward their starting position because of their abutment against the cam surface 30 of the plate 14. The weight of the structure being supported by the caster assembly 10 creates an equal and opposite force on the caster wheel 16 and its associated plate 14 pushing back against the end portions 28 of the cam arms 18. This force prevents the cam arms 18 from freely swinging back from their position, as shown in FIG. 3, to their starting position, as shown in FIG. 2. With reference to FIG. 3, it is also apparent that the cam arms 18 cannot be rotated further outward because of their abutment against the side walls 32 of the housing 12.

As best seen in FIGS. 5 and 6, to ensure that this upward force by the caster wheel 16 and its associated plate 14 against the cam arm 18 is maintained, a spring lip 34 of each end plate 24 is bent slightly upwards to act as a spring against which the plate 14 pushes as the cam arms 18 move the plate 14 to its extended position, as shown in FIG. 3. As the cam arms 18 are pivoted and reach 90 degrees from their starting position, they slightly deflect the spring lips 34 of the end plates 24, which then spring slightly back as the cam arms 18 reach their ultimate position, slightly past 90 degrees, as shown in FIG. 3. In this way, even if the upward force of the caster wheels 16 and plate 14 against the cam arms 18 is removed (e.g., if a caster wheel 16 hits a hole in the ground over which it is rolling), the spring lips 34 will maintain enough upward force against the plate 14 to prevent the cam arms 18 from unintentionally swinging back toward their starting position and releasing the caster assembly 10 from its extended position.

With the caster assembly 10 mounted on a structure, in its retracted position as shown in FIG. 2, a user inserts a hex wrench into hex features 26 of the first tube portions 20 of each cam arm 18 and rotates the wrench. This rotates the cam arms 18, pushing the plate 14 and caster wheels 16 down against the ground. As the cam arms 18 are rotated slightly past their 90 degree positions, they slightly deflect the spring lips 34 of the end plates 24, which, along with the force of the ground pushing up against the caster wheels 16 and plate 14, lock the cam arms 18 into their extended positions, as shown in FIG. 3. The caster wheels 16 are thus “locked” into their extended positions allowing the structure to which the caster assembly 10 is mounted to be rolled over the ground until a user inserts a hex wrench into the hex features 26 and pivots the cam arms 18 back to their starting positions, as shown in FIG. 2. This retracts the plate 14 and its associated caster wheels 16 into the housing 12.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described herein are further intended to explain best modes known for practicing the invention and to enable others skilled in the art to utilize the invention in such, or other, embodiments and with various modifications required by the particular applications or uses of the present invention.

1. A caster assembly comprising:
a housing;
a plate movably positioned within the housing between a retracted position and an extended position, the plate in the extended position being parallel to the plate in the retracted position;
a caster wheel rotatably coupled to the plate; and
a cam arm pivotally coupled to the housing, wherein the cam arm is pivotable to cam against the plate to move the plate from its retracted position to its extended position.

2. The caster assembly of claim 1 further comprising a second plate coupled to the housing and including a lip, wherein the plate engages the lip in the extended position and the lip provides an upward force on the plate when in the extended position.

3. The caster assembly of claim 1, wherein the cam arm is pivoted to an over-center position to move the plate to the extended position.

4. The caster assembly of claim 3 further comprising a second plate coupled to the housing and including a lip, and wherein the plate engages the lip to deflect the lip as the cam arm approaches the over-center position.

5. The caster assembly of claim 5, wherein the lip provides an upward force on the plate when the plate engages the lip.

6. The caster assembly of claim 1 further comprising a second plate coupled to the housing, the second plate defining an opening therein, wherein a portion of the cam arm extends through the opening.

7. The caster assembly of claim 1, wherein the cam arm includes three tubes connected together.

8. The caster assembly of claim 1, wherein a portion of the cam arm is manipulatable by a user to pivot the cam arm and move the plate from the retracted position to the extended position.

9. The caster assembly of claim 1, wherein the plate has a recess to receive the cam arm when the plate is in the retracted position.

10. A caster assembly comprising:
a housing;
a plate movable within the housing, the plate having two ends;
a caster wheel rotatably coupled to the plate; and
a cam arm pivotally coupled to the housing to pivot relative to the housing, wherein the cam arm cams against the plate to move the two ends of the plate vertically downward relative to the housing.

11. The caster assembly of claim 10, wherein the cam arm has a first end pivotally coupled to the housing and a second end that cams against the plate to move the plate relative to the housing.

12. The caster assembly of claim 10, wherein the cam arm is a first cam arm, the caster assembly further comprising a second cam arm pivotally coupled to the housing to pivot relative to the housing, wherein the first cam arm and the second cam arm cam against the plate to move the plate relative to the housing.

13. The caster assembly of claim 10, wherein the cam arm includes a manipulatable feature engagable by a complimentarily shaped tool to pivot the cam arm with the tool to move the plate relative to the housing.

14. The caster assembly of claim 10, further comprising an end plate coupled to the housing near a longitudinal end of the cam arm, the end plate defining an opening therein through which a portion of the cam arm extends.

15. The caster assembly of claim 14, wherein the portion of the cam arm extending through the opening is manipulatable by a user to pivot the cam arm and move the plate relative to the housing.

16. The caster assembly of claim 10, wherein the plate has a recess to receive the cam arm when the plate is in the retracted position.

17. A method of operating a caster assembly mountable to a structure, the method comprising:
mounting the caster assembly to a surface of the structure, the caster assembly including a housing, a plate moveable within the housing, a caster wheel rotatably coupled to the plate, and a cam arm coupled to the housing and engaging the plate;
rotating the cam arm to cam the cam arm against the plate; and
moving the plate relative to the housing from a retracted position to an extended position by rotating the cam arm, wherein the plate in the extended position is parallel to the plate in the retracted position.

18. The method of claim 17, wherein the plate includes two ends and wherein moving the plate further includes moving the two ends of the plate vertically downward relative to the housing from the retracted position to the extended position.

19. The method of claim 17, wherein the cam arm is a first cam arm and the caster assembly further includes a second cam arm coupled to the housing and engaging the plate, and wherein rotating further includes rotating the first and second cam arms to cam the first and second cam arms against the plate.

20. The method of claim 19, wherein moving further includes moving the plate relative to the housing from the retracted position to the extended position by rotating the first and second cam arms.

21. The method of claim 17, further comprising rotating the cam arm to allow the plate to move relative to the housing from the extended position to the retracted position.

22. The method of claim 17, wherein the cam arm is rotated in a first direction to move the plate from the retracted position to the extended position and the cam arm is rotated in a second position, opposite the first direction, to allow the plate to move from the extended position to the retracted position.
